(19) United States
(12) Patent Application Publication
(10) Pub. No.: US 2016/0059544 A1
(43) Pub. Date: Mar. 3, 2016

(54) INK-FEEDING ROLLER AND MANUFACTURING METHOD THEREFOR

(71) Applicant: KOMORI CORPORATION, Tokyo (JP)

(72) Inventor: Kyotaro ONUMA, Tsukua-shi (JP)

(73) Assignee: KOMORI CORPORATION, Tokyo (JP)

(21) Appl. No.: 14/782,016

(22) PCT Filed: Mar. 28, 2014
(86) PCT No.: PCT/JP2014/059094

§ 371 Date: Oct. 2, 2015

(30) Foreign Application Priority Data
Apr. 4, 2013 (JP) 2013-078365
Apr. 4, 2013 (JP) 2013-078366

(51) Int. Cl. B41F 31/13; B41F 31/26

(52) U.S. Cl. CPC B41F 31/13; B41F 31/26

(57) ABSTRACT

The purpose of the present invention is to provide an ink-feeding roller capable of making the thickness of the supplied ink film to be uniform and thin, and a manufacturing method therefore. For this purpose, the present invention is an ink-feeding roller (13), which is supported between an ink fountain roller (12) and an ink roller (14) so as to be capable of reciprocating movement and which supplies ink from the ink fountain roller (12) to a plate cylinder (21) via the ink roller (14) by bringing the ink-feeding roller alternately in contact with the ink fountain roller (12) and the ink roller (14). A helical groove (13a) is provided on the outer circumference thereof according to the pattern position and pattern area on the printing plate of the plate cylinder (21).

### TECHNICAL FIELD

The present invention relates to an ink ductor roller configured to supply ink stored in an ink fountain from an ink fountain roller to an ink roller, and to a manufacturing method for the ink ductor roller.

### BACKGROUND ART

Generally, a printing press is provided with an inking device configured to supply the surface of a printing plate with ink for printing. In the inking device, an ink ductor roller reciprocally moves between an ink fountain roller and an ink roller, so that ink stored in an ink fountain is transferred from the ink fountain roller to the ink roller and hence supplied to a plate cylinder.

Such an inking device is capable of adjusting the amount of ink supplied by adjusting the opening of each ink fountain key in the ink fountain (a gap between the ink fountain and the ink fountain roller), the number of revolutions of the ink fountain roller, the number of times the ink ductor roller reciprocates, and the like.

In this regard, for example, Patent Document 1 discloses a conventional inking device as described above.

### PRIOR ART DOCUMENT

### Patent Document

Patent Document 1: Japanese Patent Application Publication No. Hei 5-147200

### SUMMARY OF THE INVENTION

### Problems to be Solved by the Invention

Meanwhile, heretofore, double-sided offset printing presses have been provided for printing bank notes. The features of bank notes include not only a small pattern area, but also a light color as a whole. Hence, the aforementioned double-sided offset printing presses for bank notes need to reduce the amount of ink supplied, thereby making the thickness of a supplied-ink film uniform and thin.

However, reducing the openings of ink fountain keys requires reduction in the gap with the rotatable ink fountain roller. This may hinder a sufficient reduction in the amount of ink supplied. Moreover, it is not realistic to make the positions of the ink fountain keys correspond to the locations of small patterns. Further, reduction in the number of revolutions of the ink fountain roller or the number of times the ink ductor roller reciprocates may cause a problem in an ink flow or ink stagnation, so that the ink may not be supplied evenly. In other words, the method for adjusting the amount of ink supplied in the conventional inking device has a difficulty in making the thickness of the ink film uniform and thin by finely adjusting the amount of ink supplied.

Thus, an object of the present invention is to provide an ink ductor roller capable of making the thickness of a supplied-ink film uniform and thin in order to solve the above-described problems.

Another object of the present invention is to provide a method for manufacturing an ink ductor roller which makes it possible to easily manufacture an ink ductor roller capable of making the thickness of a supplied-ink film uniform and thin in order to solve the above-described problems.

### Means for Solving the Problems

An ink ductor roller according to a first aspect of the invention for solving the above-described problems is characterized in that
the ink ductor roller is supported to be capable of reciprocating between an ink fountain roller and an ink roller, and is configured to supply ink from the ink fountain roller to a plate cylinder via the ink roller by coming alternately into contact with the ink fountain roller and the ink roller, and
the ink ductor roller comprises a groove on a roller outer circumference thereof.

An ink ductor roller according to a second aspect of the invention for solving the above-described problems is characterized in that the groove is provided on the roller outer circumference according to a pattern position and a pattern area on a printing plate of the plate cylinder.

An ink ductor roller according to a third aspect of the invention for solving the above-described problems is characterized in that a pitch of the groove is varied according to the pattern position and the pattern area on the printing plate of the plate cylinder.

An ink ductor roller according to a fourth aspect of the invention for solving the above-described problems is characterized in that a groove width of the groove is varied according to the pattern position and the pattern area on the printing plate of the plate cylinder.

An ink ductor roller according to a fifth aspect of the invention for solving the above-described problems is characterized in that
any one of a pitch and a groove width of the groove is varied to increase a surface area of a protruding portion formed on the roller outer circumference corresponding to a region having a large pattern area on the printing plate of the plate cylinder, and
any one of the pitch and the groove width of the groove is varied to reduce the surface area of the protruding portion formed on the roller outer circumference corresponding to a region having a small pattern area on the printing plate of the plate cylinder.

An ink ductor roller according to a sixth aspect of the invention for solving the above-described problems is characterized in that the groove is a helical groove.

A method for manufacturing an ink ductor roller according to a seventh aspect of the invention for solving the above-described problems is a method for manufacturing an ink ductor roller which is supported to be capable of reciprocating between an ink fountain roller and an ink roller, and which is configured to supply ink from the ink fountain roller to a plate cylinder via the ink roller by coming alternately into contact with the ink fountain roller and the ink roller, the method characterized by comprising cutting a groove on a roller outer circumference of the ink doctor roller on basis of plate information on a printing plate of the plate cylinder by using a roller machining device.

A method for manufacturing an ink ductor roller according to an eighth aspect of the invention for solving the above-described problems is characterized in that
the plate information includes
   a pattern position and a pattern area on the printing plate of the plate cylinder, or
   plate making data for manufacturing the printing plate of the plate cylinder.

A method for manufacturing an ink ductor roller according to a ninth aspect of the invention for solving the above-described problems is characterized in that the groove is a helical groove.

A method for manufacturing an ink ductor roller according to a tenth aspect of the invention for solving the above-described problems is characterized in that the groove is a groove formed along a circumferential direction of the roller outer circumference.

### Effect of the Invention

Thus, by providing the groove on the roller outer circumference, the ink ductor roller according to the present invention makes it possible to reduce the amount of ink supplied, and is accordingly capable of making the thickness of a supplied-ink film uniform and thin.

Moreover, the method for manufacturing an ink ductor roller according to the present invention makes it possible to easily manufacture the ink ductor roller capable of making the thickness of a supplied-ink film uniform and thin, by cutting the groove on the roller outer circumference on the basis of plate information on the printing plate of the plate cylinder.

### BRIEF DESCRIPTION OF THE DRAWINGS

FIG. 1 is a schematic configuration diagram of a printing unit of a double-sided offset printing press to which an ink ductor roller according to an embodiment of the present invention is applied.

FIG. 2 is an enlarged view of substantial part in FIG. 1.

FIG. 3 is an external view of the ink ductor roller according to the embodiment of the present invention.

Parts (a), (b) of FIG. 4 are cross-sectional views of the ink ductor roller in which the pitch and the groove width of a groove are varied.

Part (a) of FIG. 5 is a view showing a state when a bank note is printed on a sheet, and part (b) of FIG. 5 is a view showing a pattern of the bank note.

FIG. 6 is an external view of an ink ductor roller according to another embodiment of the present invention.

FIG. 7 is a diagram for illustrating a method for manufacturing an ink ductor roller according to an embodiment of the present invention.

FIG. 8 is a diagram for illustrating a method for manufacturing an ink ductor roller according to another embodiment of the present invention.

### MODE FOR CARRYING OUT THE INVENTION

Hereinafter, an ink ductor roller and a manufacturing method therefore according to the present invention will be described in detail with reference to the drawings.

### Embodiments

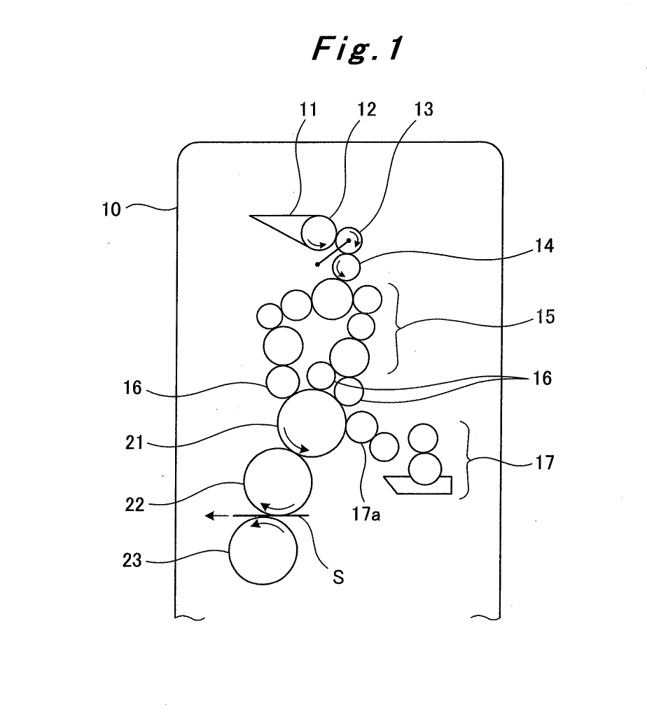

As shown in FIG. 1, a double-sided offset printing press for bank notes is provided with multiple printing units 10 along a transport direction of a sheet S. Note that FIG. 1 shows a printing unit 10 provided at the most upstream stage in the sheet transport direction as a representative among the multiple printing units 10.

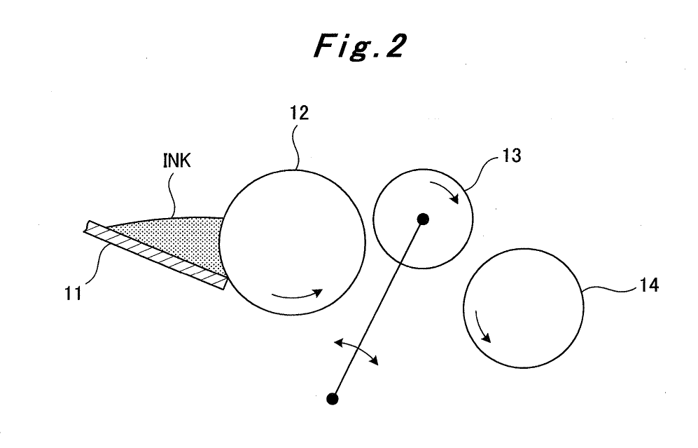

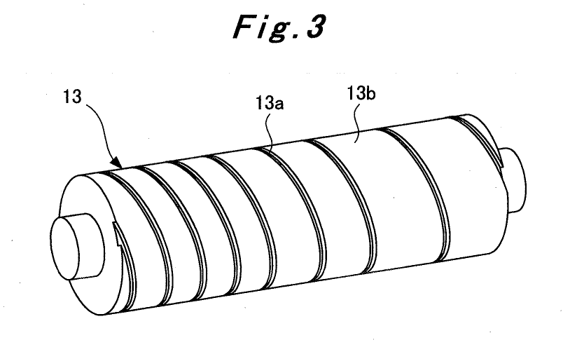

As shown in FIGS. 1 and 2, an upper portion of the printing unit 10 is provided therein with an ink fountain 11 configured to store ink, an ink fountain roller 12, an ink ductor roller 13, and an ink roller 14.

The ink fountain roller 12 is rotatably supported on an inner side of the ink fountain 11, and the ink roller 14 is configured to be rotatable on an outer side of the ink fountain 11. Moreover, the ink ductor roller 13 is rotatably supported between the ink fountain roller 12 and the ink roller 14.

The ink ductor roller 13 is swingably supported between the ink fountain roller 12 and the ink roller 14, and is capable of coming alternately into contact with the rollers 12, 14. In other words, the ink ductor roller 13 is configured to reciprocate between the ink fountain roller 12 and the ink roller 14. The reciprocal movement is in synchronism with the number of revolutions of the double-sided offset printing press in order to maintain a constant amount of ink supplied.

Further, the ink roller 14 is linked to multiple ink form rollers 16 via rollers 15. The ink form rollers 16 are in contact with a plate cylinder 21. Additionally, a dampening roller 17a of a dampener 17 is in contact with the plate cylinder 21 on an upstream side, in a rotation direction, of contact points of the plate cylinder 21 with the ink form rollers 16.

Furthermore, a blanket cylinder 22 is in contact with the plate cylinder 21 on a downstream side, in the rotation direction, of the contact points of the plate cylinder 21 with the ink form rollers 16 and on an upstream side, in the rotation direction, of the contact point with the dampening roller 17a. An impression cylinder 23 faces a point of the blanket cylinder 22 on a downstream side, in a rotation direction, of the contact point of the blanket cylinder 22 with the plate cylinder 21. In addition, the sheet S is supplied to the facing point between the blanket cylinder 22 and the impression cylinder 23.

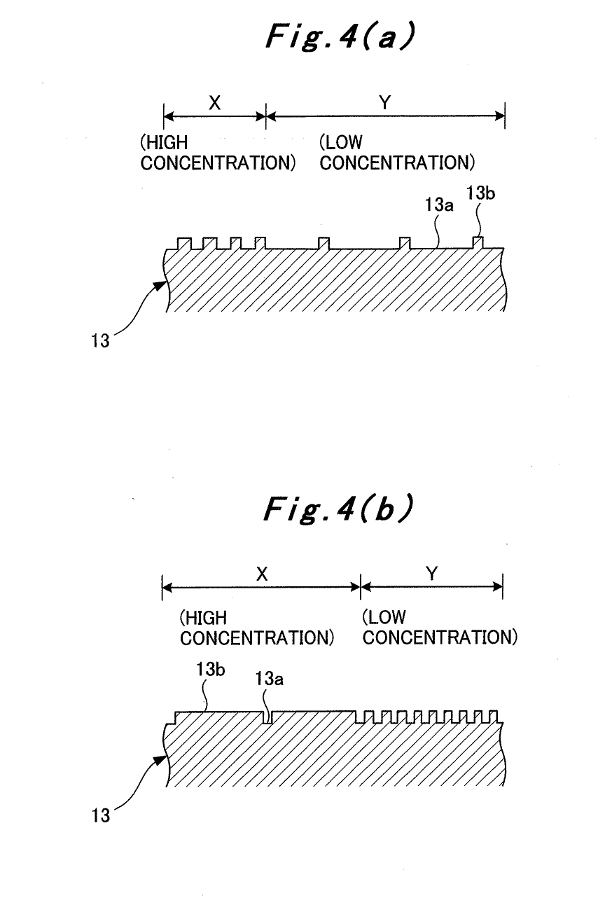

Here, the ink ductor roller 13 is formed of an elastic member such as rubber, and an outer circumference thereof is formed to have a recessed and protruding shape. Specifically, as shown in FIG. 3, a helical groove 13a is cut on the outer circumference of the ink ductor roller 13. Hence, the outer circumference of the ink ductor roller 13 includes the helical groove 13a as a recessed portion, and a helical protruding portion 13b. Ink is transferred to only the surface (outer circumferential surface) of the protruding portion 13b.

Moreover, in the ink ductor roller 13, a position and a surface area of the protruding portion 13b are adjusted with a pitch and a groove width of the groove 13a varied according to a pattern position and a pattern area (corresponding to a pattern position and a pattern area of a bank note Sa to be described later) on a printing plate of the plate cylinder 21. In this manner, in the ink ductor roller 13, the amount of ink supplied (ink film thickness) in a roller axis direction thereof is adjustable in such a way that the position and the surface area of the protruding portion 13b are adjusted by varying the pitch and the groove width of the groove 13a.

Specifically, in a cylinder axis direction of the plate cylinder 21 (printing plate), a region having a larger pattern area needs a larger amount of ink to be supplied so as to increase the ink concentration; meanwhile, a region having a smaller pattern area needs a smaller amount of ink to be supplied so as to decrease the ink concentration.

On the other hand, in the roller axis direction of the ink ductor roller 13, an ink supply region where a larger amount of ink is supplied so as to increase the ink concentration (hereinafter referred to as ink supply region X) and an ink supply region where a smaller amount of ink is supplied to decrease the ink concentration (hereinafter referred to as ink supply region Y) need to be set according to the pattern position and the pattern area on the printing plate of the plate cylinder 21.

In the ink ductor roller 13 shown in, for example, part (a) of FIG. 4, the pitch and the groove width of the groove 13a are decreased so as to increase the surface area of the protruding portion 13b, so that the ink supply region X is set. In comparison with this, the pitch and the groove width of the groove 13a are increased so as to decrease the surface area of the protruding portion 13b, so that the ink supply region Y is set.

Meanwhile, in the ink ductor roller 13 shown in part (b) of FIG. 4, the pitch of the groove 13a is increased and the groove width of the groove 13a is decreased so as to increase the surface area of the protruding portion 13b, so that the ink supply region X is set. In comparison with this, the pitch of the groove 13a is decreased and the groove width of the groove 13a is decreased so as to decrease the surface area of the protruding portion 13b, so that the ink supply region Y is set.

Note that the ink supply regions X, Y may be set by varying only the pitch of the groove 13a while keeping the groove width of the groove 13a uniform.

Thus, when the sheet S is printed, first, ink stored in the ink fountain 11 is applied to an outer circumferential surface of the ink fountain roller 12 by rotating the ink fountain roller 12.

Next, the ink applied to the ink fountain roller 12 is transferred to the ink ductor roller 13 and then transferred to the ink roller 14, by swinging the ink ductor roller 13.

The ink transferred to to the ink roller 14 is further transferred to the rollers 15 and distributed thereto in a step-by-step manner. Thereafter, the ink is transferred to the plate cylinder 21 via the ink form rollers 16. The ink transferred to the plate cylinder 21 in this manner is mixed with water supplied from the dampener 17.

After the ink mixed with water on the plate cylinder 21 is further transferred to the blanket cylinder 22, the blanket cylinder 22 transfers the ink to the sheet S at the facing point between the blanket cylinder 22 and the impression cylinder 23.

Subsequently, the sheet S is sequentially transported to the rest of the multiple printing units 10, and the printing units 10 perform such ink supply operations as described above. Thereby, multiple bank notes (notes) Sa are printed on the single sheet S as shown in part (a) of FIG. 5.

In this event, as shown in part (b) of FIG. 5, a region having a large pattern area and a region having a small pattern area co-exist on the surface (printed surface) of the bank note Sa. Nevertheless, since the recessed and protruding shape on the outer circumference of the ink ductor roller 13 corresponds to the pattern position and the pattern area on the printing plate of the plate cylinder 21 (the sheet S), the ink film thickness is uniform and thin throughout the regions.

Moreover, in the above-described embodiment, the ink ductor roller according to the present invention is applied as the ink ductor roller 13 of the double-sided offset printing press for bank notes. Nevertheless, the ink ductor roller according to the present invention is applicable also as a pair of upper and lower ink ductor rollers in a double-duct type rainbow printing press.

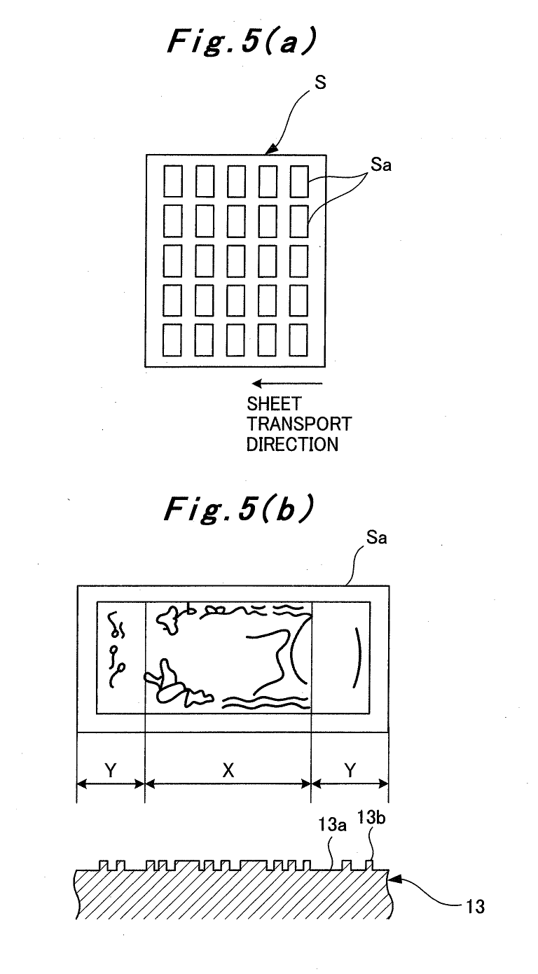

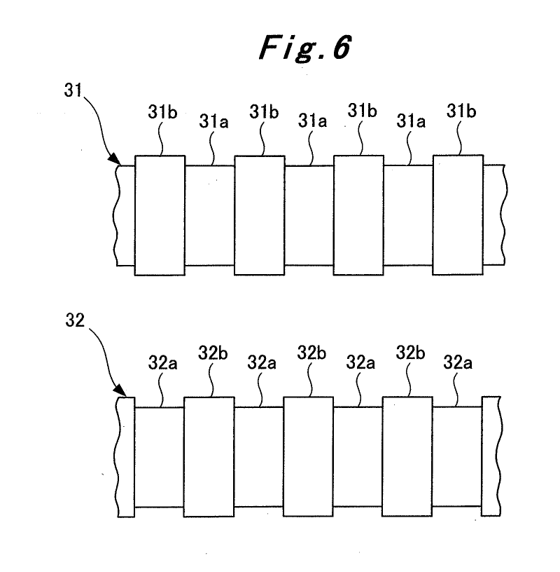

Specifically, as shown in FIG. 6, multiple grooves 31a, 32a are respectively cut along circumferential directions on outer circumferences of a pair of upper and lower ink ductor rollers 31, 32 used in a rainbow printing press. Hence, the outer circumferences of the ink ductor rollers 31, 32 include the multiple grooves 31a, 32a as recessed portions, and multiple protruding portions 31b, 32b, respectively. Ink is transferred to only surfaces (outer circumferential surfaces) of the protruding portions 31b, 32b. In this event, in roller axis directions of the ink ductor rollers 31, 32, the grooves 31a face the protruding portions 32b, while the protruding portions 31b face the grooves 32a.

Moreover, in the ink ductor rollers 31, 32, positions and surface areas of the protruding portions 31b, 32b are adjusted by varying pitches and groove widths of the grooves 31a, 32a according to the pattern position and the pattern area on the printing plate of the plate cylinder 21. In this manner, in the ink ductor rollers 31, 32, the amounts of ink supplied (ink film thicknesses) in the roller axis directions are adjustable in such a way that the positions and the surface areas of the protruding portions 31b, 32b are adjusted by varying the pitches and the groove widths of the grooves 31a, 32a.

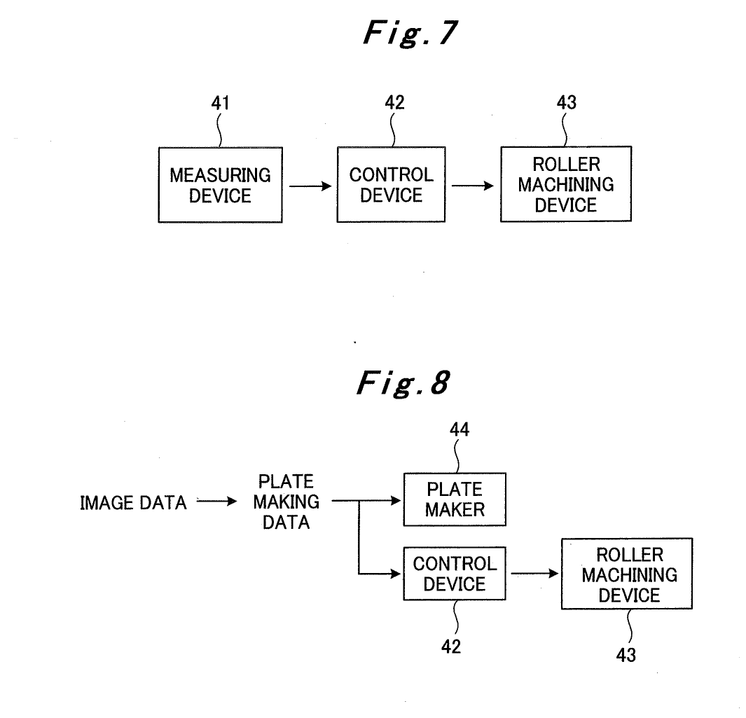

Further, when the ink ductor rollers 13, 31, 32 are manufactured, this is carried out on the basis of plate information (pattern information) including the pattern position and the pattern area on the printing plate of the plate cylinder 21 as described above. Next, the manufacturing method based on the plate information will be described with reference to FIGS. 7 and 8.

First, as illustrated in FIG. 7, when grooves are to be cut on the ink ductor rollers 13, 31, 32, a measuring device 41, a control device 42, and a roller machining device (for example, lathe) 43 are provided.

The measuring device 41 is configured to measure a pattern position and a pattern area on the printing plate of the plate cylinder 21, and is capable of outputting the measurement result to the control device 42. Moreover, the control device 42 is configured to control the roller machining device on the basis of the measurement result inputted from the measuring device 41. Further, the roller machining device 43 is configured to cut the grooves 13a, 31a, 32a on the outer circumferences while rotating the ink ductor rollers 13, 31, 32 about the respective roller axes. In other words, the roller machining device 43 is configured to cut the grooves 13a, 31a, 32a at predetermined pitches and groove widths on the basis of plate information obtained directly from the printing plate of the plate cylinder 21.

In addition, as illustrated in FIG. 8, a plate maker 44 is configured to manufacture the printing plate of the plate cylinder 21 by utilizing plate making data based on image data on the sheet S which will be a printing product. Here, the plate making data utilized when the printing plate of the plate cylinder 21 is manufactured is used as the plate information for cutting the grooves 13a, 31a, 32a. Specifically, the grooves 13a, 31a, 32a are cut at predetermined pitches and groove widths on the basis of the plate information for manufacturing the printing plate of the plate cylinder 21.

Thus, the ink ductor rollers 13, 31, 32 according to the present invention make it possible to reduce the amount of ink supplied, by varying the recessed and protruding shapes of the outer circumferences thereof according to the pattern position and the pattern area on the printing plate of the plate cylinder 21. Hence, the ink ductor rollers 13, 31, 32 are capable of making the thickness of a supplied-ink film uniform and thin on the plate cylinder 21 and the sheet S.

Further, the method for manufacturing an ink ductor roller according to the present invention makes it possible to easily manufacture the ink ductor rollers 13, 31, 32 capable of making the thickness of a supplied-ink film uniform and thin, by cutting the grooves 13a, 31a, 32a on the outer circumferences on the basis of plate information on the printing plate of the plate cylinder 21.

### INDUSTRIAL APPLICABILITY

The ink ductor roller and the manufacturing method therefore according to the present invention enable improvement in printing quality by appropriately adjusting the amount of ink supplied, and accordingly can be very advantageously used in the technical field of printing.

### REFERENCE SIGNS LIST

### 10 PRINTING UNIT

### 11 INK FOUNTAIN

### 12 INK FOUNTAIN ROLLER

### 13 INK DUCTOR ROLLER

### 13a GROOVE

### 13b PROTRUDING PORTION

### 14 INK ROLLER

### 15 ROLLERS

### 16 INK FORM ROLLER

### 17 DAMPENER

### 17a DAMPENING ROLLER

### 21 PLATE CYLINDER

### 22 BLANKET CYLINDER

### 23 IMPRESSION CYLINDER

### 31, 32 INK DUCTOR ROLLER

### 31a, 32a GROOVE

### 31b, 32b PROTRUDING PORTION

### 41 MEASURING DEVICE

### 42 CONTROL DEVICE

### 43 ROLLER MACHINING DEVICE

### 44 PLATE MAKER

### S SHEET

Sa BANK NOTE

1. An ink ductor roller characterized in that
the ink ductor roller is supported to be capable of reciprocating between an ink fountain roller and an ink roller, and is configured to supply ink from the ink fountain roller to a plate cylinder via the ink roller by coming alternately into contact with the ink fountain roller and the ink roller, and
the ink ductor roller comprises a groove on a roller outer circumference thereof.

2. The ink ductor roller according to claim 1, characterized in that the groove is provided on the roller outer circumference according to a pattern position and a pattern area on a printing plate of the plate cylinder.

3. The ink ductor roller according to claim 2, characterized in that a pitch of the groove is varied according to the pattern position and the pattern area on the printing plate of the plate cylinder.

4. The ink ductor roller according to claim 2, characterized in that a groove width of the groove is varied according to the pattern position and the pattern area on the printing plate of the plate cylinder.

5. The ink ductor roller according to claim 1, characterized in that
any one of a pitch and a groove width of the groove is varied to increase a surface area of a protruding portion formed on the roller outer circumference corresponding to a region having a large pattern area on the printing plate of the plate cylinder, and
any one of the pitch and the groove width of the groove is varied to reduce the surface area of the protruding portion formed on the roller outer circumference corresponding to a region having a small pattern area on the printing plate of the plate cylinder.

6. The ink ductor roller according to claim 1, characterized in that the groove is a helical groove.

7. A method for manufacturing an ink ductor roller which is supported to be capable of reciprocating between an ink fountain roller and an ink roller, and which is configured to supply ink from the ink fountain roller to a plate cylinder via the ink roller by coming alternately into contact with the ink fountain roller and the ink roller, the method characterized by comprising cutting a groove on a roller outer circumference of the ink ductor roller on basis of plate information on a printing plate of the plate cylinder by using a roller machining device.

8. The method for manufacturing an ink ductor roller according to claim 7, characterized in that
the plate information includes
a pattern position and a pattern area on the printing plate of the plate cylinder, or
plate making data for manufacturing the printing plate of the plate cylinder.

9. The method for manufacturing an ink ductor roller according to claim 7, characterized in that the groove is a helical groove.

10. The method for manufacturing an ink ductor roller according to claim 7, characterized in that the groove is a groove formed along a circumferential direction of the roller outer circumference.
